(19) United States
(12) Patent Application Publication
(10) Pub. No.: US 2025/0125421 A1
(43) Pub. Date: Apr. 17, 2025

(54) Electrolytes Containing Acetamide-Based Solvent, And Electrochemical Devices Incorporating Such Electrolytes

(71) Applicant: SES Holdings Pte. Ltd., Singapore (SG)

(72) Inventors: Bin Liu, Lexington, MA (US); Xinyu Li, Tustin, CA (US); Randolph Leising, North Andover, MA (US); Mingfu He, Malden, MA (US); Erik Ratta, Stoneham, MA (US); Jinyu Du, Cambridge, MA (US); Hong Gan, Woburn, MA (US); Qichao Hu, Arlington, MA (US)

(21) Appl. No.: 18/727,430

(22) PCT Filed: Jan. 10, 2023
(86) PCT No.: PCT/IB2023/050222

§ 371 Date: Jul. 9, 2024

Related U.S. Application Data
(60) Provisional application No. 63/298,008, filed on Jan. 10, 2022.

(51) Int. Cl. H01M 10/0569; H01M 10/052; H01M 10/0568

(52) U.S. Cl. CPC H01M 10/0569; H01M 10/052; H01M 10/0568; H01M 2300/0037

(57) ABSTRACT

Electrolytes that include one or more salts, one or more acetamide-based solvents, and optionally, one or more non-acetamide-based solvents. In some embodiments, disclosed electrolytes can be used in electrochemical devices, such as alkaline-metal-based (e.g., lithium-based) secondary battery cells, among others. Also disclosed are electrochemical devices that incorporate disclosed electrolytes.

### RELATED APPLICATION DATA

This application claims the benefit of priority of U.S. Provisional Patent Application Ser. No. 63/298,008, filed Jan. 10, 2022, and titled “ELECTROLYTES CONTAINING ACETAMIDE-BASED SOLVENT, AND ELECTROCHEMICAL DEVICES INCORPORATING SUCH ELECTROLYTES”, which is incorporated by reference herein in its entirety.

### FIELD OF THE INVENTION

The present invention generally relates to the field of electrolytes for electrochemical devices. In particular, the present invention is directed to electrolytes containing acetamide-based solvent, and electrochemical devices incorporating such electrolytes.

### BACKGROUND

Lithium-ion batteries using traditional carbonate-based electrolytes cannot exhibit satisfactory energy density performance. This is due to the low specific capacity of graphite (375 mAh g⁻¹) widely used as anodes of Li-ion batteries. Among all potential anode materials, lithium (Li) metal has been considered as the most promising because of its ultrahigh specific capacity (3,860 mAh g⁻¹) and lowest negative potential (−3.04 V vs. the standard hydrogen electrode). Although high energy-density lithium-metal batteries have experienced great progress over recent decades, existing electrolytes are still not good enough to acceptably resolve at least these issues: 1) limited cycle life; 2) lithium dendrite growth; and 3) poor safety (e.g., flammability of electrolytes themselves and their thermal stability with cell components at high temperature).

Generally, there are two major kinds of electrolyte solvents: one is ether and the other is carbonate. Ether oxidatively decomposes when a >4 V charging voltage is applied. Compared to ether, carbonate has relatively better oxidative stability; however, thermodynamic stability towards a Li-metal anode used in Li-metal batteries is worse than ether-based electrolytes. Clearly, both carbonate-based electrolyte systems and ether-based electrolyte systems have some limitations for Li-metal rechargeable battery applications. Discovery of a new class of solvents for Li-metal-battery electrolyte applications appears to be needed.

### SUMMARY

In one implementation, the present disclosure is directed to an electrolyte that includes a salt system that includes at least one alkaline earth metal salt and a solvent system that includes a solvent having one of Structure I and Structure II, as follows: (Structure I) R₁-CO—N—R₂R₃ wherein, R₁ can be —F, —CF₃, —CₓH_{y}F_{z} (linear or branched, x=1 to 4, y=0 to 2x+1, z=0 to 2x+1, and y+z=2x+1); R₂ and R₃ each can be —H, —CH₃₋ₐ—(CₓH_{y}F_{z})ₐ (linear or branched, x=0 to 3, y=0 to 2x+1, z=0 to 2x+1, and y+z=2x+1, a=0 to 3); and R₂≠R₃ or R₂=R₃. (Structure II) —R₁—CO—N—(R₂)—CH₂— wherein, R₁ can be −(CHₓF_{y})(CH_{z}Fₐ)— (x=0 to 2, y=0 to 2, z=0 to 2, a=0 to 2); and R₂ can be —CH₃₋ₐ—(CₓH_{y}F_{z})ₐ (linear or branched, x=1 to 3, y=0 to 2x+1, z=0 to 2x+1, and y+z=2x+1, a=0 to 3).

In another implementation, the present disclosure is directed to a method of making an electrolyte for a secondary battery that operates using a flow of ions of an alkaline earth metal between an anode and a cathode. The method includes providing at least one solvent having one of Structure I and Structure II, as follows: (Structure I) R₁-CO—N—R₂R₃ wherein, R₁ can be —F, —CF₃, —CₓH_{y}F_{z} (linear or branched, x=1 to 4, y=0 to 2x+1, z=0 to 2x+1, and y+z=2x+1); R₂ and R₃ each can be —H, —CH₃₋ₐ—(CₓH_{y}F_{z})ₐ (linear or branched, x=0 to 3, y=0 to 2x+1, z=0 to 2x+1, and y+z=2x+1, a=0 to 3); and R₂≠R₃ or R₂=R₃. (Structure II) —R₁-CO—N—(R₂)—CH₂-wherein, R₁ can be —(CHₓF_{y})(CH_{z}Fₐ)— (x=0 to 2, y=0 to 2, z=0 to 2, a=0 to 2); and R₂ can be —CH₃₋ₐ—(CₓH_{y}F_{z})ₐ— (linear or branched, x=1 to 3, y=0 to 2x+1, z=0 to 2x+1, and y+z=2x+1, a=0 to 3); providing at least one salt that comprises the alkaline earth metal; and combining the at least one solvent and the at least one salt with one another so as to make the electrolyte.

In yet another implementation, the present disclosure is directed to an

electrochemical device that includes an anode comprising an alkaline earth metal; a cathode; a separator located between the anode and the cathode; and an electrolyte saturating the separator and being in operative communication with each of the anode and the cathode.

### BRIEF DESCRIPTION OF THE DRAWINGS:

For the purpose of illustration, the drawings show aspects of one or more example embodiments. However, it should be understood that the present disclosure is not limited to the precise arrangements and instrumentalities shown in the drawings, wherein:

FIG. 1 is a diagram illustrating lowest unoccupied molecular orbit (LUMO) and highest occupied molecular orbit (HOMO) values of example acetamide-based solvents A through G of this disclosure;

FIG. 2 is a graph of current density versus voltage illustrating a linear scan voltammetry of 8M of lithium bis (fluorosulfonyl) imide (LiFSI)-dimethyltrifluoroacetamide (DTA) electrolyte at scan of 1 mV/s;

FIG. 3 is a graph of current density versus voltage illustrating aluminum corrosion evaluation of 8M LiFSI-DTA electrolyte at scan rate of 5 mV/s;

FIG. 4 is graph of heat flow versus temperature illustrating low temperature differential scanning calorimetry characterization of 4.3M LiFSI-DTA electrolyte at a scan rate of 5° C./min;

FIG. 5 is a graph of heat flow versus temperature illustrating high temperature differential scanning calorimetry characterization of fully charged (State of Charge: 100%) high-Ni NMC cathode with 8M LiFSI-DTA electrolyte and fully charged (State of Charge: 100%) high-Ni NMC cathode with 1M LiPF₆-EC/EMC (v: v=1:1) electrolyte at scan rate of 10° C./min;

FIG. 6 contains two photographs taken during a flammability assessment of a DTA solvent; and

FIG. 7 is a high-level schematic diagram illustrating an electrochemical device made in accordance with principles of the present disclosure.

### DETAILED DESCRIPTION:

In this disclosure, unexpected findings on new acetamide-based electrolytes are presented. These findings demonstrate that such acetamide-based solvents provide improved electrolyte properties and improved Li-metal cell performance.

Before proceeding with a description, it is noted that the term “about” when used with a corresponding numeric value or other quantitative measure refers to ±20% of the numeric value, typically ±10% of the numeric value, often ±5% of the numeric value, and most often ±2% of the numeric value. In some embodiments, the term “about” can mean the numeric value itself.

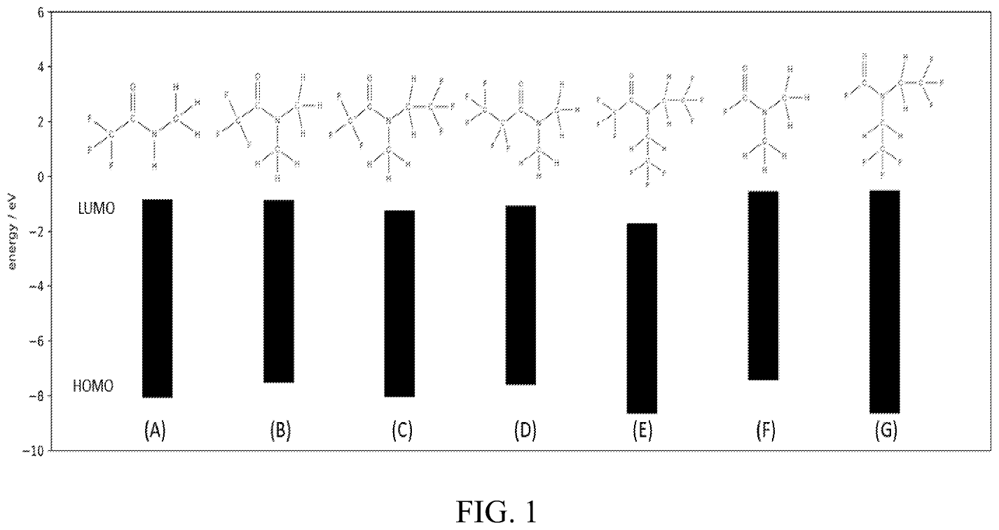

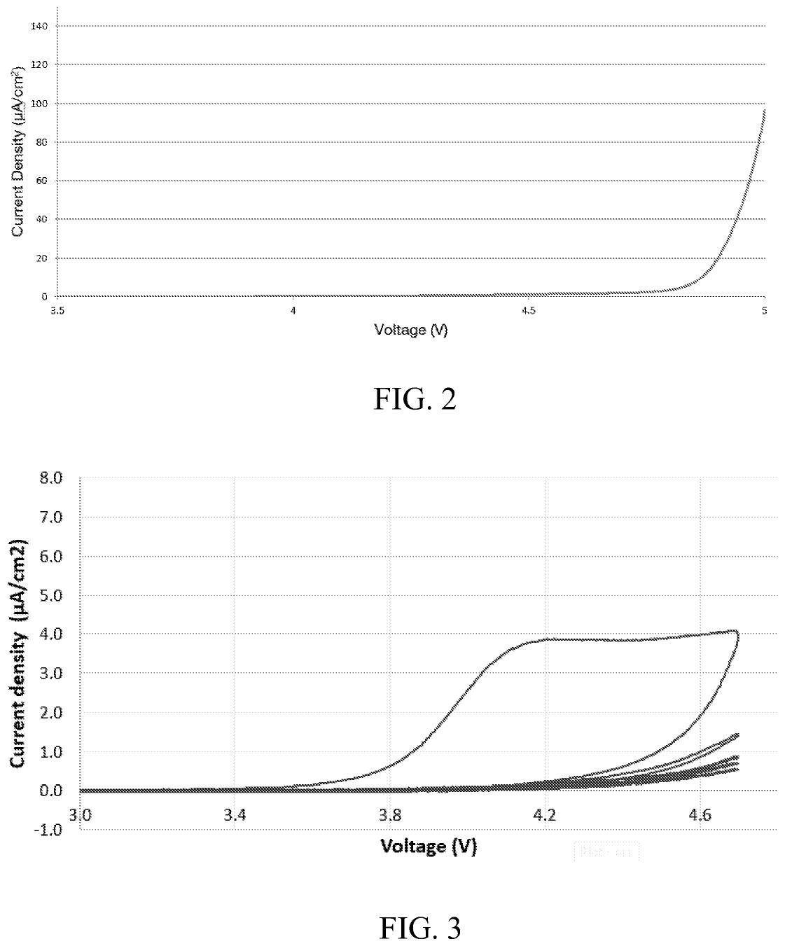

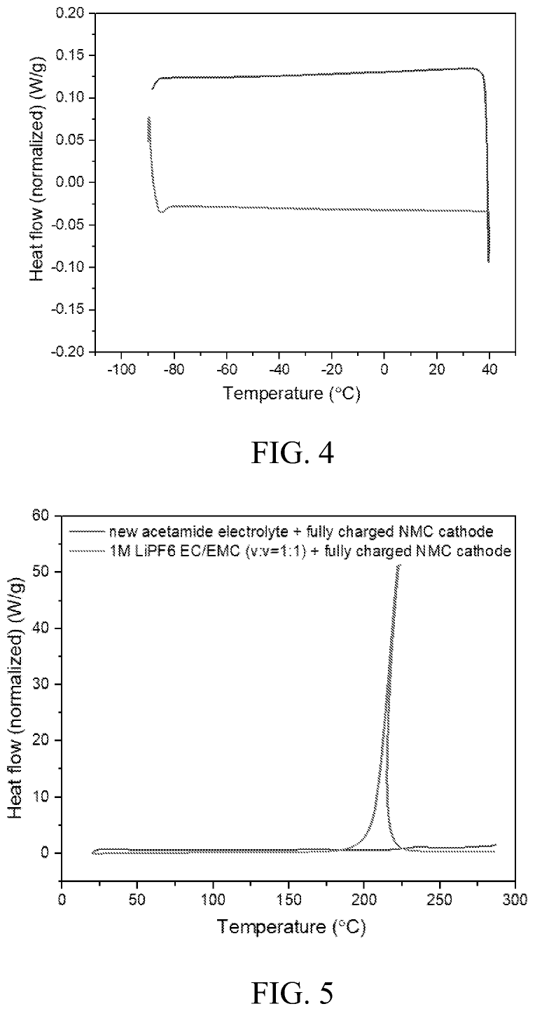

Disclosed herein is a new class of acetamide-based solvents, including the example solvents listed as A through G in FIG. 1, but are not only limited to those example solvents. The solvents disclosed herein have a wide voltage window according to lowest unoccupied molecular orbit (LUMO) and highest occupied molecular orbit (HOMO) values calculations. For example, (CH₃)₂NCOCF₃ (solvent B listed in FIG. 1) is dimethyltrifluoroacetamide (DTA). The oxidative stability voltage of an 8 M lithium bis (fluorosulfonyl) imide (LiFSI)-DTA electrolyte is more than 4.7 V, as shown in FIG. 2, and this can fit for high voltage battery application requirements. Also, surfaces of aluminum (Al) can be passivated via an 8 M LiFSI-DTA electrolyte, with the passivated Al demonstrating no corrosion (FIG. 3). In addition, it has been observed that there is no thermal phase transition for a 4.3M LiFSI-DTA electrolyte between −90° C. and 40° C. Consequently, embodiments of this new class of electrolyte can be applied in a wide temperature range because of a relatively extremely wide liquid-state phase temperature range (down to −90° C.), as illustrated in FIG. 4.

In a high temperature differential scanning calorimetry (DSC) characterization, the amount of heat generated by a new electrolyte of the present disclosure (4.3 M LiFSI-DTA) with fully charged (State of Charge: 100%) high-Ni nickel-manganese-cobalt oxide (NMC) cathodes at high temperature is much less than that of traditional commercialized Li-ion battery electrolyte (1 M LiPF₆-ethylene carbonate (EC)/ethyl methyl carbonate (EMC), v:v=1:1). This demonstrates that the new electrolyte is able to improve safety (e.g., common thermal runaway) (FIG. 5).

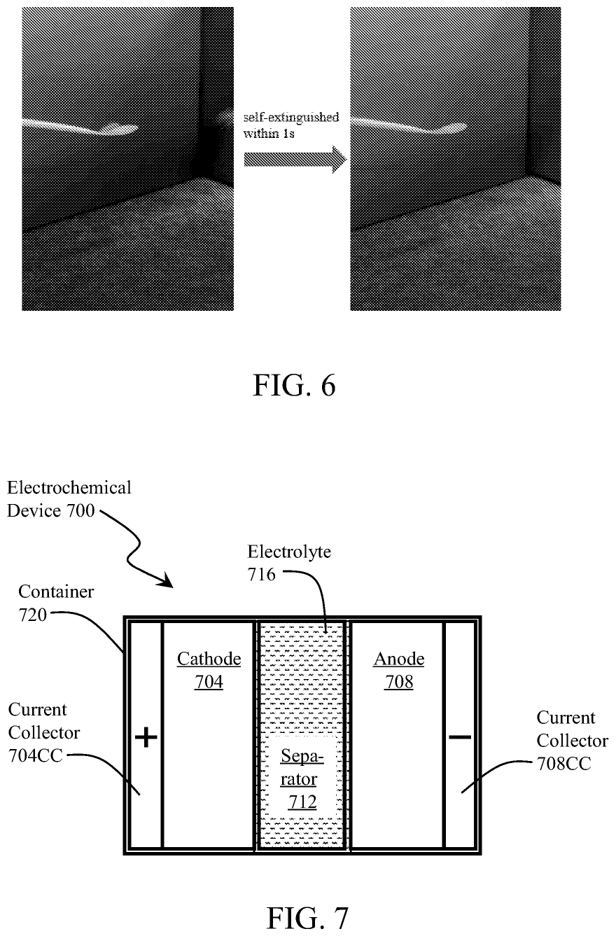

FIG. 6 illustrates an evaluation of a flammability property of DTA as the acetamide-based solvent. The DTA solvent could be ignited, but, interestingly, it then self-extinguished in a quite short time (<1 s). Considering the above very good thermal stability and self-extinguished feature/very low flammability of solvents presented herein, a new class of acetamide-based electrolytes can be beneficial for key cell safety improvements.

In this disclosure, some embodiments of an acetamide-based solvent of the present disclosure are represented by the following general chemical structure:

R₁-CO—N—R₂R₃ (Structure I)

wherein:
R₁ can be —F, —CF₃, —CₓH_{y}F_{z} (linear or branched, x=1 to 4, y=0 to 2x+1, z=0 to 2x+1, and y+z=2x+1);
R₂ and R₃ each can be —H, —CH₃₋ₐ—(CₓH_{y}F_{z})ₐ (linear or branched, x=0 to 3, y=0 to 2x+1, z=0 to 2x+1, and y+z=2x+1, a=0 to 3); and
R₂≠R₃ or R₂=R₃.

Not bound to this list, some examples of acetamide-based solvents having Structure I, above, are as follows (letters in brackets denote the corresponding solvent of FIG. 1): 1) R₁ is —F, R₂ is —CH₃, R₃ is —CH₃, solvent is F—CO—N—(CH₃)₂ [F]; 2) R₁ is —F, R₂ is —CH₂CF₃, R₃ is —CH₂CF₃, solvent is F—CO—N—(CH₂CF₃)₂ [G]; 3) R₁ is —F, R₂ is —CH₂CF₃, R₃ is —CH₃, solvent is F—CO—N—(CH₂CF₃)(CH₃); 4) R₁ is —CF₃, R₂ is —CH₃, R₃ is —CH₃, solvent is CF₃—CO—N—(CH₃)₂ [B]; 5) R₁ is —CF₃, R₂ is —CH₂CF₃, R₃ is —CH₂CF₃, solvent is CF₃—CO—N—(CH₂CF₃)₂ [E]; 6) R₁ is —CF₃, R₂ is —CH₂CF₃, R₃ is —CH₃, solvent is CF₃-CO—N—(CH₂CF₃) (CH₃) [C]; 7) R₁ is —CF₃CF₂, R₂ is —CH₃, R₃ is —CH₃, solvent is CF₃CF₂—CO—N—(CH₃)₂ [D]; and 8) R₁ is —CF₃, R₂ is —H, R₃ is —CH₃, solvent is CF₃—CO—N—HCH₃ [A].

In this disclosure, some embodiments of an acetamide-based solvent can be cyclic acetamide-type solvents and can be represented by the following general chemical structure (here, R₁ is connected with—CH₂-to form a five-membered ring):

-R₁-CO—N—(R₂)—CH₂— (Structure II)

wherein:
R₁ can be —(CHₓF_{y})(CH_{z}Fₐ)— (x=0 to 2, y=0 to 2, z=0 to 2, a=0 to 2); and
R₂ can be —CH₃₋ₐ—(CₓH_{y}F_{z})ₐ— (linear or branched, x=1 to 3, y=0 to 2x+1, z=0 to 2x+1, and y+z=2x+1, a=0 to 3).

Not bound to this list, some examples of acetamide-based solvents having Structure II, above, are as follows: 1) R| is —CF₂CF₂—, R₂ is —CH₃, solvent is —CF₂CF₂-CO—N—(CH₃)—CH₂-2) R₁ is —CFHCFH—, R₂ is —CH₃—, solvent is —CFHCFH—CO—N—(CH₃)—CH₂—; and 3) R₁ is —CH₂CH₂—, R₂ is —CHCF₃—, solvent is —CH₂CH₂—CO—N—(CHCF₃)—CH₂—.

The electrolytes of this disclosure may comprise a solvent system (i.e., a single solvent or a mixture of two or more solvents) containing a single acetamide-based solvent having either Structure I or Structure II, above, or may contain a mixture of two or more types of acetamide-based solvents, each having either Structure I or Structure II above, with each solvent ranging from 100% to 0.05% by volume, by weight, or by mole ratio. A consideration for mixing two or more acetamide-based solvents is whether or not differing properties and/or differing functions of multiple solvents will provide improvements, relative to a single acetamide-based solvent, to requirements of the particular application at issue. For example, one special consideration originates from the salt solubility of the solvent(s). Acetamide-based solvents of the present disclosure that contain more fluorine atoms per molecule have reduced solubility but they exhibit high stability, while other acetamide solvents with relatively fewer fluorine atoms per molecule and good salt solubility can be combined with a solvent having a relatively greater number of fluorine atoms per molecule to provide a solvent system having the beneficial attributes of both solvents.

In addition, a solvent system of the present disclosure may further contain one or more other types of solvents, with each such other solvent being either non-fluorinated or fluorinated, to create a hybrid solvent system, i.e., a solvent system composed of one or more acetamide-based solvents and one or more non-acetamide-based solvents. A point of consideration as to whether any non-acetamide-based solvent should be used is whether or not an exclusively acetamide-based solvent system can achieve certain needed electrolyte features and functions for a particular application. If not, one or more non-acetamide-based solvents can be combined with one or more acetamide-based solvents of this disclosure to create a hybrid solvent system. By implementing a hybrid solvent system, some properties of the resulting hybrid electrolyte (i.e., a hybrid solvent system plus one or more salts) can be carefully regulated to achieve better overall electrolyte performance by leveraging the respective merits of the multiple solvents.

Examples of non-acetamide-based solvents that can be used to create a hybrid solvent system via mixing with one or more acetamide-based solvents include, but are not limited to: 1) ethers, e.g., methyl propyl ether, methyl butyl ether, ethyl propyl ether, ethyl butyl ether, propyl butyl ether, diethyl ether, dipropyl ether, and dibutyl ether, 1,2-diethoxy ethane, 1,2-dimethoxy ethane, 1,2-dipropoxyethane, and 1,2-dibutoxyethane, bis (2-methoxyethyl) ether, 2-ethoxyethyl ether, 1,2-(1,1,2,2-tetrafluoroethoxy) ethane, 1,1,2,2-tetrafluoroethyl 2,2,3,3-tetrafluoropropyl ether, 1,3-dioxolane, 1,4-dioxane, 1,3-dioxane, tetrahydropyran, tetrahydrofuran, 2,4-dimethyltetrahydrofuran, 2-methyltetrahydrofuran, 3-methyltetrahydrofuran, and 2-ethyl-5-methyltetrahydrofuran; 2) carbonates, e.g., dimethyl carbonate, ethylmethyl carbonate, diethyl carbonate, ethylene carbonate, propylene carbonate, vinylene carbonate, and fluoroethylene carbonate, and 3) sulfamoyl-based solvent, e.g., N,N-dimethylsulfamoyl fluoride, N,N-ethylmethylsulfamoyl fluoride, and N,N-dimethyltrifluoromethane-sulfonamide, among others. In some embodiments each of the at least one non-acetamide-based solvent may be selected from a group consisting of ethers, carbonates, sulfonyls, nitriles, phosphates, sulfonates, sultones, sulfates, ionic liquids, phosphonates, phosphites, sulfones, sulfonyl isocyanates, and orthoformate solvents, with each solvent in the acetamide-based solvent system ranging, for example, from about 100% to about 0.05% by volume ratio, by weight ratio, or by mole ratio, each relative to the solvent system, or in a range of about 5% to about 50% by volume ratio, by weight ratio, or by mole ratio, each relative to the solvent system. As those skilled in the art will understand, various ones of the above-mentioned and/or other solvent materials can be used as a solvent for the electrolyte or an additive for the electrolyte, generally depending on the relative amount of the solvent material used in the electrolyte.

An electrolyte of the present disclosure may include a suitable salt system (i.e., a single salt or a combination of two or more salts) in solution with a suitable solvent system, such as a solvent system composed as discussed immediately above, so as to provide a novel electrolyte. In the context of lithium-based electrochemical devices (e.g., Li-metal secondary cells) and sodium-based electrochemical devices (e.g., Na-metal secondary cells), the following lithium-based and sodium-based salts can be, respectively, combined with any of the above acetamide-based solvent systems to create corresponding electrolytes: LiFSI, LiTFSI, LiClO₄, LiBF₄, LiPF₆, LiAsF₆, LiTf, LiBETI, LICTFSI, LITDI, LIPDI, LIDCTA, LiB(CN)₄, LiBOB, LiDFOB, and LiDFP, among others, and NaFSI, NaTFSI, NaCIO₄, NaBF₄, NaPF₆, NaAsF₆, NaTf, NaBETI, NaCTFSI, NaTDI, NaPDI, NaDCTA, NaB(CN)₄, NaBOB, NaDFOB, and NaDFB, among others. In some embodiments, the salt system, which can be either a single salt or a combination of salts, may have a concentration within the electrolyte of about 0.1M up to about 10M or more, of about 0.1 M to about 5 M, of about 0.5 M to about 5 M, or of about 0.5 M to about 3 M, among other ranges, to suit a particular application. As those skilled in the art will understand, various ones of the above-mentioned and/or other salt materials can be used as a salt for the electrolyte or an additive for the electrolyte, generally depending on the relative amount of the salt material used in the electrolyte.

Working principles: Advantages of electrolytes of this disclosure may include, but not be limited to, any one or more of the following: 1) good compatibility and chemical stability with Li-metal anodes and cathode material in lithium batteries; 2) high oxidative stability at high voltage (>4.7V); 3) dense passivation layer on anode surface and cathode surface to protect electrodes; 4) high thermal stability at high temperature (<2 W/g heat flow output when heating electrolyte with fully charged cathode to 290° C.); 5) wide operation temperature (−90° C.˜80° C.); and 6) self-extinguished and low flammable property (self-extinguished time is less than 1 s).

Key technical problem: Some key technical problems facing Li-metal secondary batteries are less-than-ideal safety performance and shortened cycle life. For these issues, the electrolyte used in an Li-metal battery plays an important role in dominating battery performance in terms of safety and electrochemical performance.

The technical solution: The new class of acetamide-based electrolytes disclosed herein is able to exhibit good chemical compatibility with anode and cathode materials, improved thermal stability, low flammability, and enhanced oxidative stability at high voltage, which can benefit for obvious improvement in cycle life. By combining the new class solvents disclosed herein with electrolyte formulation design (e.g., depending on extraordinary coordination ability of invented acetamide solvents with salt to enable high salt: solvent mole ratio to provide highly coordinated salt-solvent clusters and minimize free solvent and maximize salt-driven solid electrolyte interphase (SEI) protective layer on an anode surface), Li-metal batteries relying on solvents disclosed herein are highly expected to illustrate long-lasting cycles and improved safety. In some embodiments, to minimize free solvent within an acetamide-based electrolyte it is desired to make the salt: solvent ratio (e.g., LiFSI: DTA mole ratio) equal to or greater than about 1:2 and equal to or less than about 1:0.5 (such as, e.g., 1:2, 1:1.8, 1:1.6, 1:1.4, 1:1.2, 1:1, among others) to make the salt start to decompose for a better salt-derived SEI passivation layer formation on the anode surface. In a particular instantiation in which the salt is LiFSI and the acetamide-based solvent is DTA, it was found that the critical point of the LiFSI:DTA mole ratio to minimize the amount of free solvent is about 1:1.75. Other salt+solvent combinations of the present disclosure can have other salt: solvent mole ratios.

### Example Electrochemical Cell

FIG. 7 illustrates, in a highly-simplistic form, an example electrochemical device 700 that can be made in accordance with aspects of the present disclosure. Those skilled in the art will readily appreciate that the example electrochemical device 700 can be, for example, a battery cell, such as a secondary battery cell, or a supercapacitor, among other things. In addition, those skilled in the art will readily understand that FIG. 7 illustrates only some of the basic functional components of an electrochemical device and that a real-world instantiation of the electrochemical device, such as a secondary battery cell or a supercapacitor, will typically be embodied using either a stacked construction or a wound construction composed of or forming one or more of the various layers depicted in FIG. 7. Further, those skilled in the art will understand that the electrochemical device 700 may include other components, such as electrical leads, electrical terminals, seal(s), thermal shutdown layer(s), electrical circuitry, gas-gettering feature(s), and/or vent(s), and sensors, among other things, that, for ease of illustration, are not shown in FIG. 7.

In this example, the electrochemical device 700 of FIG. 7 includes a spaced-apart cathode 704 and anode 708 and a pair of corresponding respective current collectors 704CC and 708CC. A porous dielectric separator 712 is located between the cathode 704 and the anode 708 to electrically separate them from one another while allowing ions within an electrolyte 716 made in accordance with the present disclosure to flow therethrough. The porous dielectric separator 712 may be made of any one or more suitable materials, such as any conventional separator materials, such as, but not limited to a polyolefin, a polyolefin blend, a ceramic coated polyolefin or polyolefin blend, to name just a few nonlimiting examples that those of ordinary skill in the art will know. The porous dielectric separator 712 and/or one, the other, or both of the cathode 704 and the anode 708, depending on whether porous (e.g., of the intercalating type) or not, may be impregnated at least partially with the electrolyte 716. The electrochemical device 700 includes a sealed container 720 that contains at least the cathode 704, the anode 708, the porous dielectric separator 712, and the electrolyte 716. As those skilled in the art will readily appreciate, the container 720 may be any suitable type of container, such as a pouch-type container, a cylindrical-type container, or a button-cell-type container, among others, and made of any suitable type(s) of material(s). Those skilled in the art will readily understand the type that the container 720 may be and the material(s) that the container made be made of suitable for any particular instantiation of the electrochemical device 700, as there are many well-known container types and materials of construction used for such container types.

As those skilled in the art will understand, depending upon the type and design of the electrochemical device 700, each of the cathode 704 and the anode 708 comprises one or more suitable materials compatible with the salt ions and other constituents of the electrolyte. In some embodiments, the anode 708 may be an active-metal anode that functions by plating/stripping of an active metal (e.g., lithium, lithium alloy, sodium, sodium alloy, or other alkaline earth metal or alkaline earth metal alloy) during charging/discharging. In some embodiments, the anode 708 may be, for example, of the intercalating/de-intercalating type, with the active material being any suitable anode active material, such as, but not limited to, natural graphite, artificial graphite, activated carbon, carbon black, conductive additives, lithium titanate, surface-functionalized silicon, and high-performance powdered graphene, among others. The cathode 704 may comprise any suitable cathode active material, such as, but not limited to, a multi-metal oxide that contains cobalt, nickel, and/or manganese, a metal fluoride, and a lithium metal phosphate, among others. Each of the current collectors 704CC and 708CC may be made of any suitable electrically conducting material, such as copper or aluminum, among others. Many battery and supercapacitor constructions that can be used for constructing the electrochemical device of FIG. 7 are known in the art, such that it is not necessary to describe them in any detail for those skilled in the art to understand how to make and use the various aspects of the present disclosure to their fullest scope.

As those skilled in the art will readily appreciate, the presence of the electrolyte 716, which is made in accordance with this disclosure, provides novelty to the electrochemical device 700. The electrolyte 716 may be any formulation disclosed herein by way of explicit example, method of formulation, and/or underlying fundamental principle(s).

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure and the invention(s) disclosed herein.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure and invention(s) disclosed herein.

1. An electrolyte comprising:
a salt system that includes at least one alkaline earth metal salt; and
a solvent system that includes a solvent having one of Structure I and Structure II, as follows:
R₁-CO—N—R₂R₃ (Structure I)
wherein, in Structure I:
R₁ can be —F, —CF₃, —CₓH_{y}F_{z} (linear or branched, x=1 to 4, y=0 to 2x+1, z=0 to 2x+1, and y+z=2x+1);
R₂ and R₃ each can be —H, —CH₃₋ₐ—(CₓH_{y}F_{z})ₐ (linear or branched, x=0 to 3, y=0 to 2x+1, z=0 to 2x+1, and y+z=2x+1, a=0 to 3); and
R₂≠R₃ or R₂=R₃.
-R₁-CO—N—(R₂)—CH₂— (Structure II)
wherein, in Structure II:
R₁ can be —(CHₓF_{y})(CH_{z}Fₐ)— (x=0 to 2, y=0 to 2, z=0 to 2, a=0 to 2); and
R₂ can be —CH₃₋ₐ—(CₓH_{y}F_{z})ₐ (linear or branched, x=1 to 3, y=0 to 2x+1, z=0 to 2x+1, and y+z=2x+1, a=0 to 3).

2. The electrolyte of claim 1, wherein the at least one alkaline earth metal salt is a lithium salt.

3. (canceled)

4. The electrolyte of claim 1, wherein the electrolyte has a salt-system concentration in a range of about 0.1 M to about 10 M.

5. The electrolyte of claim 1, wherein the electrolyte has a salt-system concentration in a range of about 0.5 M to about 5 M.

6. The electrolyte of claim 1, wherein the solvent system consists essentially of one or more solvents of Structure I.

7. The electrolyte of claim 1, wherein the solvent system consists essentially of one or more solvents of Structure II.

8. The electrolyte of claim 1, wherein the solvent system comprises a solvent of Structure I and a solvent of Structure II.

9. The electrolyte of claim 1, wherein the solvent system consists essentially of:
one or more solvents of either Structure I or Structure II or of both of Structures I and II;
and at least one non-acetamide-based solvent.

10. The electrolyte of claim 9, wherein the at least one non-acetamide-based solvent is selected from the group consisting of carbonate-based solvents, ether-based solvents, and sulfonyl-based solvents.

11. The electrolyte of claim 1, wherein the solvent system comprises any one or more of the following solvents: CF₃—CO—N—HCH₃; CF₃—CO—N—(CH₃)₂; CF₃—CO—N—(CH₂CF₃)(CH₃); CF₃CF₂—CO—N—(CH₃)2; CF₃—CO—N—(CH₂CF₃)₂; F—CO—N—(CH₃)2; and F—CO—N—(CH₂CF₃)₂.

12. The electrolyte of claim 1, wherein the solvent system consists essentially of any one or more of the following solvents: CF₃—CO—N—HCH₃; CF₃—CO—N—(CH₃)2; CF₃—CO—N—(CH₂CF₃)(CH₃); CF₃CF₂—CO—N—(CH₃)2; CF₃—CO—N—(CH₂CF₃)₂; F—CO—N—(CH₃)2; and F—CO—N—(CH₂CF₃)₂.

13. The electrolyte of claim 1, wherein the solvent system consists of any one or more of the following solvents: CF₃—CO—N—HCH₃; CF₃—CO—N—(CH₃)2; CF₃—CO—N—(CH₂CF₃)(CH₃); CF₃CF₂—CO—N—(CH₃)2; CF₃—CO—N—(CH₂CF₃)₂; F—CO—N—(CH₃)2; and F—CO—N—(CH₂CF₃)₂.

14. The electrolyte of claim 1, wherein the solvent system comprises any one or more of the following solvents: —CF₂CF₂—CO—N—(CH₃)—CH₂—, —CFHCFH—CO—N—(CH₃)—CH₂—, and —CH₂CH₂-CO—N—(CHCF₃)—CH₂—.

15. The electrolyte of claim 1, wherein the solvent system consists essentially of any one or more of the following solvents: —CF₂CF₂—CO—N—(CH₃)—CH₂—, —CFHCFH—CO—N—(CH₃)—CH₂—, and—CH₂CH₂-CO—N—(CHCF₃)—CH₂—.

16. The electrolyte of claim 1, wherein the solvent system consists of any one or more of the following solvents: —CF₂CF₂—CO—N—(CH₃)—CH₂—, —CFHCFH—CO—N—(CH₃)—CH₂—, and —CH₂CH₂—CO—N—(CHCF₃)—CH₂—.

17. A method of making an electrolyte for a secondary battery that operates using a flow of ions of an alkaline earth metal between an anode and a cathode, the method comprising:
providing at least one solvent having one of Structure I and Structure II, as follows:
R₁-CO—N—R₂R₃ (Structure I)
wherein, in Structure I:
R₁ can be —F, —CF₃, —CₓH_{y}F_{z} (linear or branched, x=1 to 4, y=0 to 2x+1, z=0 to 2x+1, and y+z=2x+1);
R₂ and R₃ each can be —H, —CH₃₋ₐ—(CₓH_{y}F_{z})ₐ (linear or branched, x=0 to 3, y=0 to 2x+1, z=0 to 2x+1, and y+z=2x+1, a=0 to 3); and
R₂≠R₃ or R₂=R₃.
-R₁-CO—N—(R₂)—CH₂— (Structure II)
wherein, in Structure II:
R₁ can be —(CHₓF_{y})(CH_{z}Fₐ)— (x=0 to 2, y=0 to 2, z=0 to 2, a=0 to 2); and
R₂ can be —CH₃₋ₐ—(CₓH_{y}F_{z})ₐ— (linear or branched, x=1 to 3, y=0 to 2x+1, z=0 to 2x+1, and y+z=2x+1, a=0 to 3);
providing at least one salt that comprises the alkaline earth metal; and
combining the at least one solvent and the at least one salt with one another so as to make the electrolyte.

18. The method of claim 17, wherein the electrolyte has a desired salt concentration and combining the at least one solvent and the at least one salt with one another includes combining the at least one solvent and the at least one salt with one another in amounts that create the desired salt concentration.

19. The method of claim 18, wherein the desired salt concentration is in a range of about 0.1 M to about 10 M.

20. (canceled)

21. (canceled)

22. (canceled)

23. (canceled)

24. (canceled)

25. The method of claim 17, further comprising providing at least one non-acetamide-based solvent and combining the at least one non-acetamide-based solvent, the at least one solvent, and the at least one salt with one another so as to make the electrolyte.

26. The method of claim 25, wherein the at least one non-acetamide-based solvent is selected from a group consisting of ethers, carbonates, sulfonyls, nitriles, phosphates, sulfonates, sultones, sulfates, ionic liquids, phosphonates, phosphites, sulfones, sulfonyl isocyanates, and orthoformate solvents, with each solvent in the acetamide-based solvent system ranging from about 100% to about 0.05% by volume ratio, by weight ratio, or by mole ratio, or in a range of about 5% to about 50% by volume ratio, by weight ratio, or by mole ratio.

27.-30. (canceled)
